(19) United States
(12) Patent Application Publication
(10) Pub. No.: US 2011/0310877 A1
(43) Pub. Date: Dec. 22, 2011

(54) Coverage Extension Using Carrier Diversity In Multi-Carrier Communication Systems

(76) Inventors: Kam H. Wu, Bridgewater, NJ (US); Emad N. Farag, Flanders, NJ (US); Shin Horng Wong, Chippenham (GB)

(21) Appl. No.: 12/819,909

(22) Filed: Jun. 21, 2010

(51) Int. Cl. H04J 1/00; H04B 7/02

(52) U.S. Cl. 370/343; 375/267

(57) ABSTRACT

Embodiments are described to address coverage difference problems in communication systems (300) that operate in multiple frequency bands. Embodiments are described that utilize both Carrier Multiplexing and Carrier Diversity for a plurality of frequency carriers that exhibit a difference in coverage due to differences in path loss. Carrier Diversity is selected for carriers for which one or more of such selected carriers have a smaller coverage in order to increase the signal-to-noise ratio of the diversity combined carriers. This can effectively extend the coverage of diversity combined carriers to match those with larger coverage in Carrier Multiplexing mode.

### BACKGROUND OF THE INVENTION

1. Field of the Invention

This invention relates generally to communication systems, and, more particularly, to wireless communication systems.

2. Description of the Related Art

This section introduces aspects that may help facilitate a better understanding of the inventions. Accordingly, the statements of this section are to be read in this light and are not to be understood as admissions about what is prior art or what is not prior art.

Universal Mobile Telecommunications System (UMTS) is the leading 3G wireless system, which is specified by 3GPP. Currently, in 3GPP, a four-carrier High Speed Downlink Packet Access (4C-HSDPA) feature is being specified for Release 10. In 4C-HSDPA, a sector is defined as the geographical coverage area of a Node B (NB). A sector can consist of several wireless communication resources called cells, where each cell intends to cover the same geographical area and uses a separate frequency carrier for its transmission. 4C-HSDPA is an extension to Dual Cell (or Dual Carrier) High Speed Downlink Packet Access (DC-HSDPA), where in 4C-HSDPA a User Equipment (UE) can receive up to four simultaneous downlink transmissions from four different cells. These cells can be distributed among two different frequency bands. A frequency band is defined as a block of spectrum dedicated for a set of specific wireless operating carriers. The spectrum separation, between two frequency bands in 4C-HSDPA can be far apart. 4C-HSDPA can potentially double and quadruple the downlink throughputs of DC-HSDPA and SC (Single Cell)-HSDPA respectively. A three-carrier version, designated as 3C-HSDPA, can also be employed by using three carriers instead of four carriers. Both versions can be referred to as MC-HSDPA (Multi-Carrier HSDPA).

4C-HSDPA or 3C-HSDPA (denoted as 4/3C-HSDPA hereafter) consists of one primary (or anchor) carrier (PC) and up to three or two secondary carriers (SC) respectively. The secondary carriers are denoted as Secondary Carrier 1 (SC1), Secondary Carrier 2 (SC2) and Secondary Carrier 3 (SC3). The primary carrier contains essential downlink and uplink control channels and cannot be deactivated while any of the secondary carriers can be deactivated by the NB using an HS-SCCH (High Speed Shared Control Channel) order. Herein, if the carriers are allocated among two frequency bands, the frequency band that contains the primary carrier is referred to as the Primary Band while the other frequency band is referred to as the Secondary Band. Configurations with different band/carrier combinations are shown in diagram 100 of FIG. 1.

The coverage of 4/3C-HSDPA is similar to that in single-carrier HSDPA. A network operator may own spectrum licences to use frequency blocks in two different frequency bands. To reduce the cost of additional infrastructure, the same infrastructure is usually used to operate both bands. This requires that NBs, operating in two different bands, be collocated and share the same antenna tower. Propagation path loss is frequency band specific. A carrier in an upper band suffers more path loss and building penetration loss than one in a lower frequency band. Collocating cells operating in two different bands often creates unequal coverage.

Since the carriers in 4/3C-HSDPA can be allocated in two frequency bands, the coverage of the Primary and Secondary Bands may be different especially if one band is transmitted at a much higher frequency than the other. For example, the Dual-Band DC-HSDPA Band Combination 1 in 3GPP TS25.104 (Table 5.0A) consists of Band I (2110-2170 MHz) and Band VIII (925-960 MHz) in Europe. The lower Band VIII (925-960 MHz) has larger sector coverage due to lower path loss than that in the upper Band I (2110-2170 MHz).

This is illustrated in diagram 200 of FIG. 2, where the smaller blue area is covered by the upper band while the larger green area is covered by the lower band. The upper band may have propagation path loss in the order of 3 to 5 dB higher than that in the lower band at cell edge. Usually the Primary Band is located in the lower band due to its larger coverage. In diagram 200, a UE moving from point A to B would start to lose its upper band coverage at point B, which is the cell edge of the upper band. Further movement of the UE from point B to C would risk very low downlink data throughput and increased transmission errors in the upper band. This may force the network to abandon transmission on the secondary band, thereby further reducing downlink data throughput for UEs located at cell edge. Note that this coverage issue does not affect the uplink in 4/3C-HSDPA since the uplink is served by the primary carrier in only the Primary Band. The secondary band is not used for the uplink in the current specification for 4/3C HSDPA.

At present, approaches to this coverage difference problem include the following:
1. Increase the transmit power of the base station. This requires a Power Amplifier (PA) with higher RF output capability which is costly. Linearity of such a power amplifier may also be degraded. Also, government regulations usually do not allow transmission power beyond what is already permitted.
2. Current transmit diversity usually exploits spatial or polarization diversity which requires the antenna of each diversity branch to be located at different locations or with different polarizations. Real estate on a base station site is usually very limited and hence additional cables and antennas may not be suitable for every site. Polarization diversity is often less effective due to higher signal correlation between diversity branches, especially in rural and suburban environments. Furthermore, each transmit branch may not be able to transmit higher power since the combined emissions from all branches may violate government requirements.
3. Use of smaller HSDPA transport block sizes thereby providing the necessary higher coding gain and reducing the required sensitivity of the receiver. However, this would further reduce the user throughput at cell edge.
   Thus, new mechanisms and techniques that are able to address this coverage difference problem would advance wireless communications generally.

### SUMMARY OF THE INVENTION

Various methods are provided to address the coverage difference problem described above. One method includes transmitting, in a carrier multiplexing mode, to a receiver wirelessly and simultaneously via each of a plurality of frequency carriers a different information stream; determining based upon channel quality information to switch from the carrier multiplexing mode to a carrier diversity mode; and transmitting, in the carrier diversity mode, to the receiver wirelessly and simultaneously via each of the plurality of frequency carriers a single information stream. An article of manufacture is also provided, the article comprising a processor-readable storage medium storing one or more software programs which when executed by one or more processors performs the steps of this method.

Many embodiments are provided in which the method above is modified. Some embodiments further include transmitting, in the carrier diversity mode, transmitting to the receiver wirelessly and simultaneously via each of a second plurality of frequency carriers a second information stream. Some embodiments, either additionally or alternatively, further include transmitting, in the carrier diversity mode, to the receiver wirelessly and simultaneously via each of the plurality of frequency carriers a Hybrid ARQ (HARQ) transmission. Moreover, in some of these embodiments the HARQ transmission transmitted via a first carrier of the plurality of frequency carriers has a different redundancy version (RV) than the HARQ transmission transmitted via a second carrier of the plurality of frequency carriers, the first and second carriers being different carriers.

Another, or perhaps additional, method includes simultaneously receiving wireless signals conveying a single information stream via each of a plurality of frequency carriers; performing at least one of soft combining or selective combining of the signals received via each of the plurality of frequency carriers; and transmitting, based upon the received signals, channel quality information and ACK/NACK information. An article of manufacture is also provided, the article comprising a processor-readable storage medium storing one or more software programs which when executed by one or more processors performs the steps of this method.

Many embodiments are provided in which the method above is modified. In some embodiments, the channel quality information comprises combined channel quality information for the plurality of frequency carriers. In some embodiments, the ACK/NACK information comprises combined ACK/NACK information for the plurality of frequency carriers. Some embodiments, either additionally or alternatively, further include simultaneously receiving additional wireless signals conveying a second information stream via each of a second plurality of frequency carriers, performing at least one of soft combining or selective combining of the additional signals received via each of the second plurality of frequency carriers, and transmitting, based upon the additional received signals, additional channel quality information and additional ACK/NACK information corresponding to the second plurality of frequency carriers.

Various transceiver node apparatuses are also provided. A first transceiver node being configured to communicate with other wireless devices of a communication system and being operative to transmit, in a carrier multiplexing mode, to a receiver wirelessly and simultaneously via each of a plurality of frequency carriers a different information stream, to determine based upon channel quality information to switch from the carrier multiplexing mode to a carrier diversity mode, and to transmit, in the carrier diversity mode, to the receiver wirelessly and simultaneously via each of the plurality of frequency carriers a single information stream. A second transceiver node being configured to communicate with other wireless devices of a communication system and being operative to simultaneously receive wireless signals conveying a single information stream via each of a plurality of frequency carriers, to perform at least one of soft combining or selective combining of the signals received via each of the plurality of frequency carriers, and to transmit, based upon the received signals, channel quality information and ACK/NACK information.

### BRIEF DESCRIPTION OF THE DRAWINGS

FIG. 1 is a block diagram depiction of various configurations of four- and three-carrier HSDPA in downlink Primary and Secondary bands.

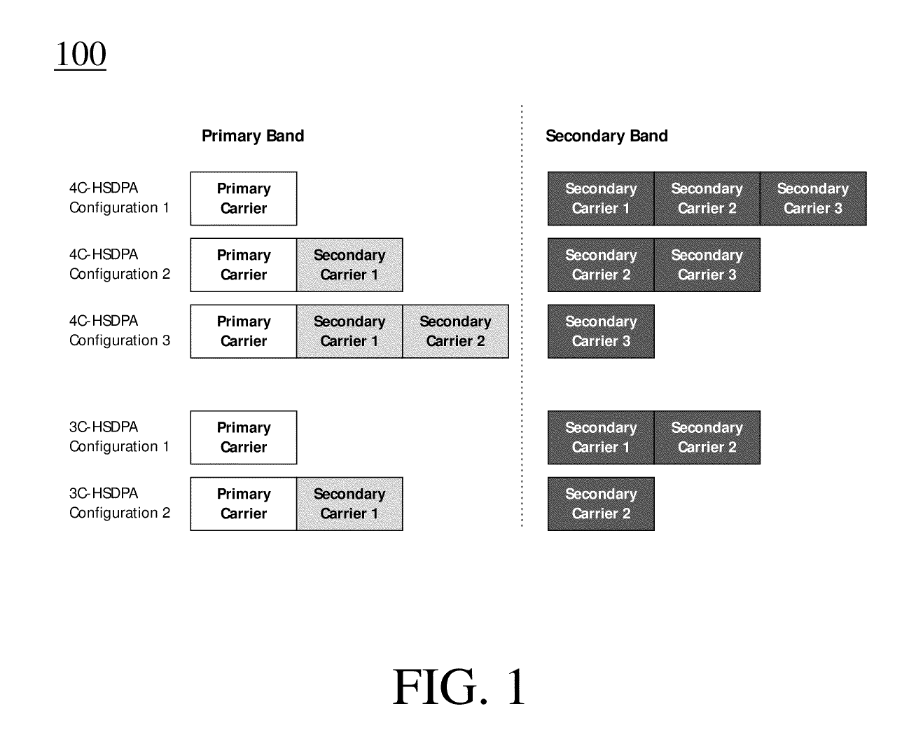

FIG. 2 depicts differences in coverage due to dual frequency band operation.

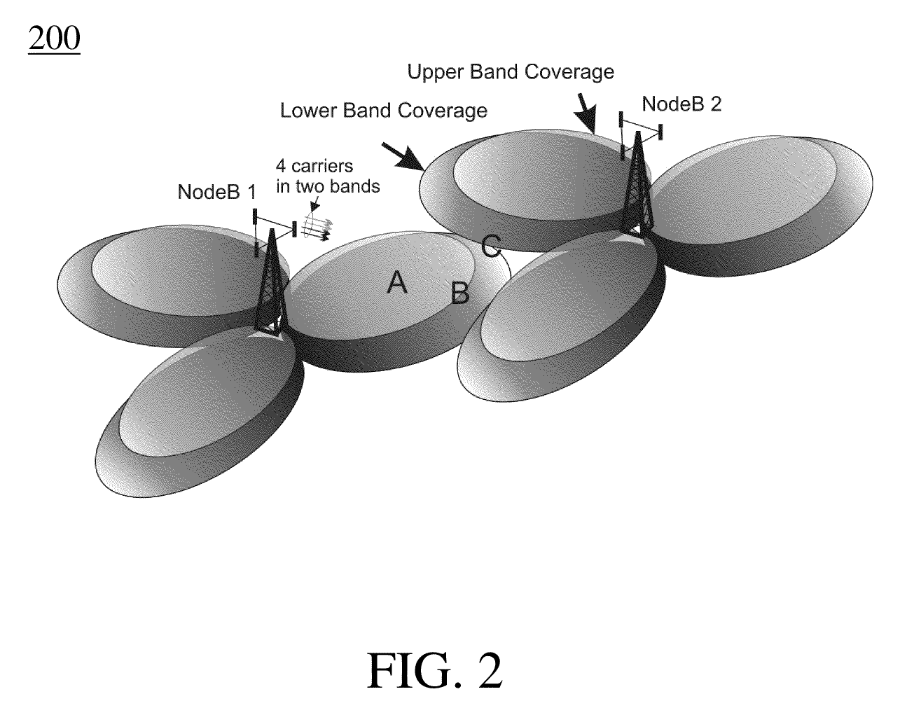

FIG. 3 depicts the potential upper band extension of coverage provided by Carrier Diversity, in accordance with various embodiments of the present invention

FIG. 4 is a graph depicting theoretical pre-Turbo decoded bit-error rates for balanced and unbalance diversity (as computed from Eq. 1 and Eq.3), in accordance with various embodiments of the present invention.

FIG. 5 is a block diagram depiction of various changes in HS-DPCCH format for Carrier Diversity, in accordance with various embodiments of the present invention.

FIG. 6 is a block diagram depiction of a parallel, dual-carrier HARQ design, in accordance with various embodiments of the present invention (Carrier Multiplexing carriers are not shown).

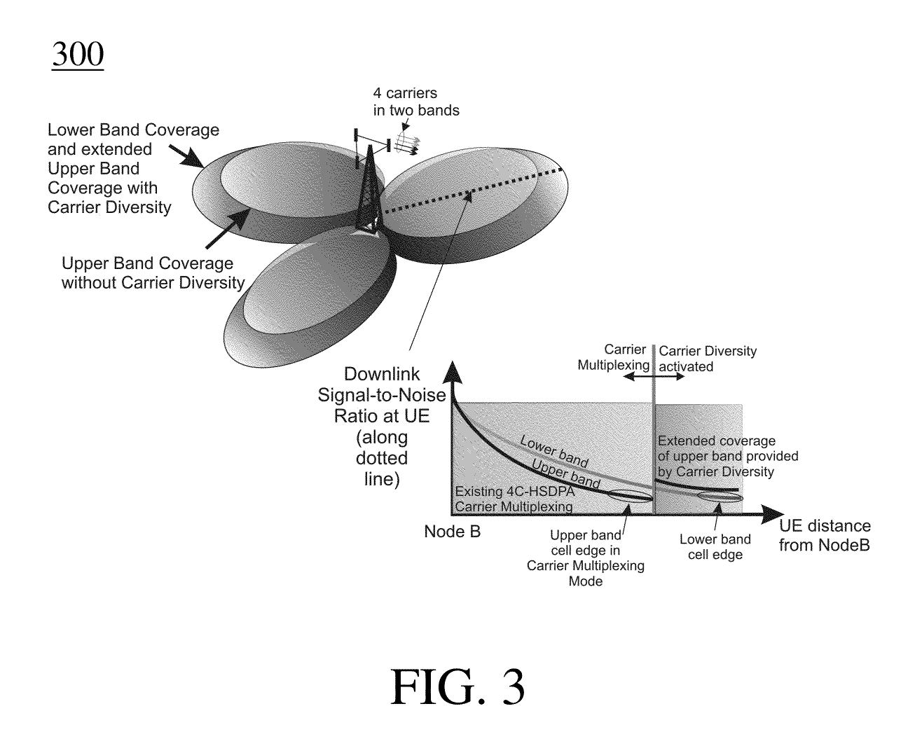

Specific embodiments of the present invention are disclosed below with reference to FIGS. 3-6. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic and/or messaging flow diagrams above are described and shown with reference to specific steps performed and/or messaging communicated in a specific order, some of these steps and/or messaging may be omitted or some of these steps and/or messaging may be combined, sub-divided, or reordered without departing from the scope of the claims. Thus, unless specifically indicated, the order and grouping of steps and/or messaging is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF SPECIFIC EMBODIMENTS

To provide a greater degree of detail in making and using various aspects of the present invention, a description of our approach to dynamic resource access and a description of certain, quite specific, embodiments follows for the sake of example. FIGS. 3-6 are referenced in an attempt to illustrate some examples of specific embodiments of the present invention and/or how some specific embodiments may operate.

Various embodiments are described herein to extend the coverage of a 4/3C-HSDPA system. This will benefit the operator since no additional dual-band NBs are required to cover just the coverage holes in the upper band at cell edge. For dual-band operation, certain embodiments can further extend the coverage of the upper band thereby improving the upper band cell edge throughputs. The enhancement at the cell edge and the extension of the coverage can be achieved by utilizing the existing resources present in 4/3C-HSDPA.

In 4/3C-HSDPA, the NB and UE are designed to transmit and receive in four or three simultaneous carriers. Since the carriers are transmitted at different frequencies in the same frequency band or different frequency bands, naturally, frequency diversity exists among these carriers. In WCDMA, over-the-air signals are more likely to undergo frequency selective fading; hence, signals among the diversity branches are uncorrelated. One basic idea of this approach is to utilize these carriers to provide diversities to the UE in the form of frequency diversity or better described herein as Carrier Diversity. Carrier Diversity is a form of frequency diversity in the sense that both carriers transmit the same information over different sources or media to the UE to provide diversity gain. However, unlike a conventional transmit diversity scheme, Carrier Diversity in 4/3C-HSDPA potentially has the following advantages:
1. Common transmit diversity utilizes only spatial or polarization diversity since the same signal is transmitted over two antennas at the same time. Time diversity may also be utilized if a second signal is also transmitted with a time delay. These types of diversity usually have a certain level of correlation between diversity branches. Carrier Diversity in WCDMA operates in a wider bandwidth and wider carrier separation so that each carrier bandwidth experiences frequency selective fading, which in turn ensures a very low correlation between diversity branches even in the same band.
2. Each carrier can be transmitted in full power. This potentially quadruples the transmit power (from four carriers) without any additional cost and does not violate any existing government regulatory requirements.
3. Current transmit diversity system has only two transmit diversity branches. A higher number of branches requires extra transmission chain at the NB and additional receiver capabilities at the UE (e.g. to differentiate the signal), which increases both NB and UE complexity. Our approach does not require additional complexity in the NB or UE other than what is already required in 4/3C-HSDPA since the NB and UE are already designed to transmit and receive in different carriers.
4. Carrier Diversity can work with other common transmit diversity without any additional changes to the existing transmit diversity to provide higher diversity gains to the UE.

The additional transmission power and frequency diversity offered by Carrier Diversity requires that some (or all) of the carriers are used to carry the same information rather than different information. The use of carriers to transmit different information is referred to herein as Carrier Multiplexing. The goal of this technique is to salvage a weak out-of-coverage downlink carrier by pairing it with another carrier either in the same or different frequency bands using Carrier Diversity in order to enhance the signal-to-noise ratio of the combined signal, which effectively extends its coverage. Note that an individual carrier at the cell edge may not be able to support the call thus causing it to drop. In the case of dual-band operation, this leads to deactivation of the carriers in the upper band, thereby causing a further reduction in throughput. Carrier Diversity allows UE at the cell edge to combine the weak carriers to form a signal strong enough to support the call. Carrier Diversity may only be activated when the UE is located beyond the cell edge of the upper band, whereas Carrier Multiplexing may be used when the UE is within the coverage of both bands. This scenario is shown in diagram 300 of FIG. 3, where the extended coverage of the upper band is provided by Carrier Diversity. It is possible that the throughput may actually increase at cell edge by using Carrier Diversity to compensate for the low throughout before switching from Carrier Multiplexing to Carrier Diversity. This is because in Carrier Multiplexing, each individual carrier may have a poor radio condition (e.g. low signal-to-noise ratio, SNR) resulting in low throughput and the summation of all these throughputs may be lower than that offered by Carrier Diversity. The reason is that Carrier Diversity improves the SNR thereby allowing a larger transport block to be transmitted to the UE. The NB can thus decide to change to Carrier Diversity if the expected combined throughput from Carrier Multiplexing is lower than that of Carrier Diversity and vice versa.

A weak out-of-coverage carrier selected for Carrier Diversity can be paired with another equally weak carrier in the same band or a not-so-weak carrier in the lower band, but preferably in the same band for higher diversity gain. The SNRs of carriers in different bands would be distinctly different due to different path losses and if they are paired for Carrier Diversity, the diversity combining will be unbalanced. On the other hand, if the paired channels are in the same band, the path losses and hence the SNRs of the two carriers are the same, so the diversity combining is balanced. For a balanced diversity case, the bit-error rate is given by

$${P}_{B , balanced} = \frac{1}{2} [ 1 - \sqrt{\frac{γ}{γ + 1}} ( 1 + \frac{1}{2 ( γ + 1 )} ) ] \qquad ( 1 )$$

where γ is the average value of SNR per bit for BPSK and QPSK.

In cases where the signal levels among k independent channels are different (unbalanced), the bit-error rate after Maximum Ratio Combining is given by

$${P}_{B , unbalanced} = \frac{1}{2} [ 1 - {\sum }_{k = 1}^{K} {ρ}_{k} \sqrt{\frac{{γ}_{k}}{{γ}_{k} + 1}} ] , where {ρ}_{k} = {\prod }_{i = 1 , i \neq k}^{K} \frac{{γ}_{k}}{{γ}_{k} - {γ}_{i}} \qquad ( 2 )$$

(See eq. 31 of Error Rates For Rayleigh Fading Multichannel Reception of MPSK Signals, by Sandeep Chennakeshu and John B. Anderson, IEEE Transactions on Communications, vol. 43, no. 2/3/4, pp. 338-346, February/March/April 1995.) Hence, the bit-error rate for an unequal dual-channel diversity case (k=2) is given by

$${P}_{B , unbalanced} = \frac{1}{2} [ 1 - ( \frac{{γ}_{1}}{{γ}_{1} - {γ}_{2}} ) \sqrt{\frac{{γ}_{1}}{{γ}_{1} + 1}} - ( \frac{{γ}_{2}}{{γ}_{2} - {γ}_{1}} ) \sqrt{\frac{{γ}_{2}}{{γ}_{2} + 1}} ] \qquad ( 3 )$$

where γ₁ and γ₂ are the average values of SNR per bit in the first and second channels. Note that (3) is equal to (1) in the limit as γ₁→γ₂. The above BER equations assume that the channels have independent (uncorrelated) Rayleigh fading, which is a valid assumption in this case of frequency diversity in WCDMA.

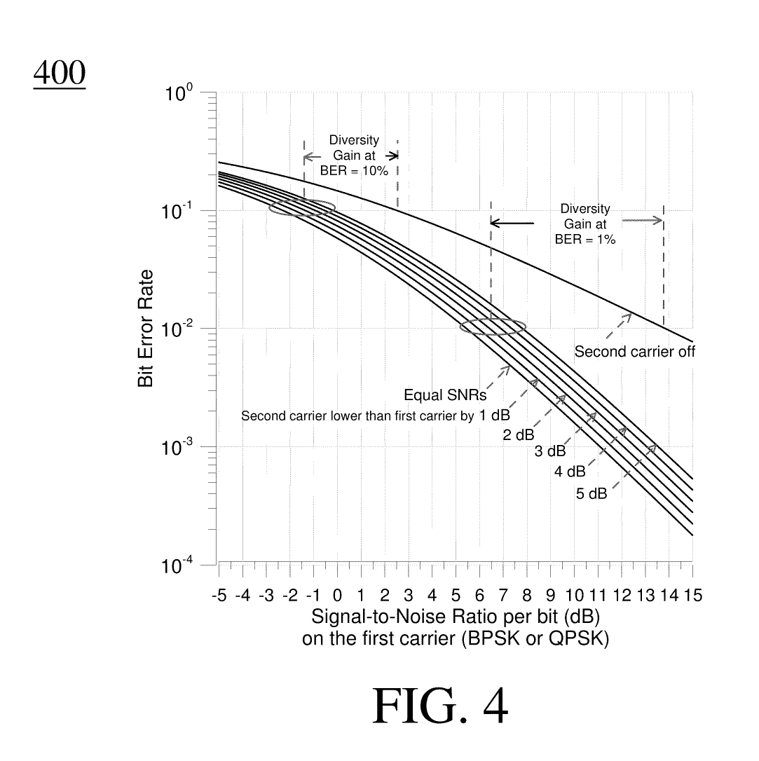

Plots of BER with different second carrier extra power losses are shown in graph 400 of FIG. 4. Extra second carrier losses are 0 (balanced), 1, 2, 3, 4, 5 dB and infinite (i.e. second carrier turned off). In the plot, the first carrier refers to the one with higher SNR (usually in the lower band) and the second carrier refers to the one with lower SNR (usually in the upper band).

In a dual-band 4/3C-HSDPA system, possible combinations of carrier distribution and pairing of carriers for Carrier Diversity are shown in Table 1. The primary carrier, PC, provides CQI and ACK/NACK information in uplink for all primary and secondary carriers in both bands.

TABLE 1
Combinations of Carrier Multiplexing and Carrier Diversity
carrier pairs for dual-band 4/3C-HSDPA UEs at cell edge.

| | | Number of | | Carrier | Balanced/ |
|---|---|---|---|---|---|
| | Total | Carriers in | Number of | Diversity | Unbalanced |
| | Number | Lower | Carriers in | Pairs at | Diversity |
| Cases | of Carriers | Band | Upper Band | Cell Edge | Combining |
| 1 | 3 (3C- | 1 (PC) | 2 (SC1, SC2) | SC1, SC2 | Balanced |
| | HSDPA) | | | | |
| 2 | 3 (3C- | 2 | 1 (SC2) | SC1, SC2 | Unbalanced |
| | HSDPA) | (PC, SC1) | | | |
| 3 | 4 (4C- | 2 | 2 (SC2, SC3) | SC2, SC3 | Balanced |
| | HSDPA) | (PC, SC1) | | | |

Theoretical diversity gains relative to single carrier (the one with higher SNR) at BER of 1% and 10% are tabulated in Table 2. A BER of 10% is more likely to be representative of a poor cell edge condition. These figures represent the maximum theoretical diversity gains. When paired carriers are in the same upper band, balanced diversity provides a higher gain to help two weak carriers to maintain good throughput in one paired stream. When paired carriers are in different bands, unbalanced diversity provides extra gain (albeit a bit lower) to the carrier in the lower band thereby boosting downlink throughput. Even at 10% pre-Turbo decoded BER, a theoretical Carrier Diversity gain of 4.8 dB is possible for balanced cases 1 and 3 in Table 1 at cell edge. The minimum gain is 3 dB. A practical gain of about 4 dB can be expected, which is sufficient to compensate for the path loss difference between the two bands at cell edge. For case 2, a gain of up to 2.7 dB to the secondary carrier (SC1) in the lower band is possible.

TABLE 2
Downlink diversity gain relative to single carrier.

| | |
|---|---|
| Second carrier extra | Diversity gain relative to single carrier |
| path loss relative to | (dB) |

| first carrier (dB) | BER = 10% | BER = 1% |
|---|---|---|
| 0 (Balanced) | 4.8 | 8.4 |
| 1 | 4.3 | 7.9 |
| 2 | 3.9 | 7.4 |
| 3 | 3.4 | 6.9 |
| 4 | 3.1 | 6.5 |
| 5 | 2.7 | 6.0 |

Switching between Carrier Multiplexing and Carrier Diversity can be commanded by the NB. An HS-SCCH order can be sent by the NB to the UE to change the UE from Carrier Multiplexing to Carrier Diversity and vice versa. The NB can use the Channel Quality Indicator (CQI) to decide when the UE can perform better in Carrier Diversity. The NB can also combine only specific carriers for Carrier Diversity while the remaining carriers can be used for Carrier Multiplexing, as recommended in Table 1. In general, the carriers selected for Carrier Diversity may be only secondary carriers or may be a combination of a primary carrier with one or more secondary carriers. It is also possible to divide the carriers into two groups where each group forms a combination for Carrier Diversity. For example, if four carriers C1, C2, C3 and C4 are available, the NB can combine C1 & C2 for Carrier Diversity (CD1) and C3 & C4 for another Carrier Diversity (CD2). Here two streams of information can still be sent to the UE where each stream consists of a combination of two carriers (i.e. Carrier Multiplexing using two groups of Carrier Diversity).

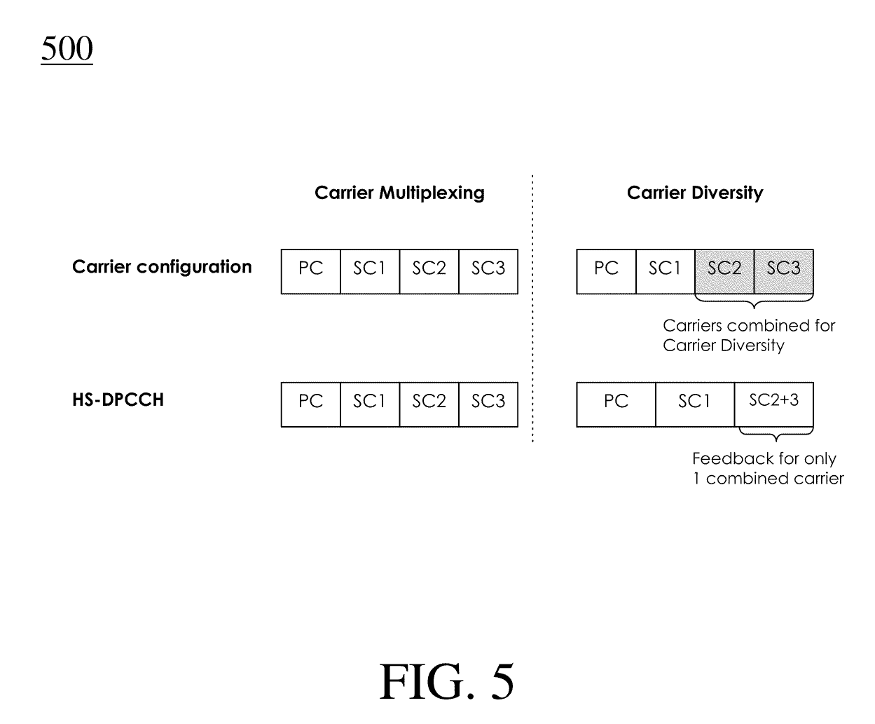

HS-DPCCH (High Speed Dedicated Physical Control Channel) is an uplink feedback channel that contains the HARQ acknowledgements (ACK/NACK), CQI and PCI (Precoding Control Indication) for each active carrier. The HS-DPCCH format changes as the number of activated carriers changes (e.g. due to activation/deactivation of secondary carriers via HS-SCCH order). In Carrier Diversity, when a carrier is used for Carrier Diversity, it becomes part of a transmission stream and hence the number of information streams is reduced. For an example of 4C-HSDPA see diagram 500 of FIG. 5. On the left hand side, four carriers are operating in Carrier Multiplexing and the corresponding HS-DPCCH feedbacks information for four carriers. On the right hand side of diagram 500, carriers SC2 and SC3 are paired for Carrier Diversity and hence they effectively become “one carrier” since they transmit the same information and the corresponding HS-DPCCH only needs feedback information for three carriers. This is done since the UE produces a combined CQI for the paired carriers so that the NB is able to allocate the right transport block size for this combined carrier. Similarly, a single combined ACK/NACK is fed back via HS-DPCCH to the NB. The NB can use this combined CQI to decide when to switch back to Carrier Multiplexing (e.g. if the CQI is sufficiently high, then it may be more effective to switch to Carrier Multiplexing mode by sending two independent information streams on SC2 and SC3). If instead of sending a single combined CQI for the paired carriers, the HS-DPCCH feeds back the individual's original CQIs for C2 and C3 before they are combined; it provides the NB with the actual downlink channel conditions of the individual carriers that can be better used as an indicator for switching back to Carrier Multiplexing. The following issues are present in using this approach:
1. The ACK/NACK may also need to be separated for each carrier. This causes a mismatch in the number of HARQ entities and the number of ACK/NACK (e.g. 3 HARQ entities versus 4 ACK/NACK). The UE also need to decide whether to send an ACK or a NACK on each carrier given that the packet is decoded after soft combining (e.g. the packet is received correctly after combining, the UE needs to figure out whether to send ACK in each carrier or ACK for one carrier and DTX the rest).
2. If ACK/NACK are not separated for each carrier, a new HS-DPCCH design is required to send more CQIs than ACK/NACK.
3. The NB needs to estimate the effective CQI from the individual CQIs in order to allocate the appropriate transport block.
4. Depending on the UE, it may need to perform additional decoding for each individual carrier to work out the appropriate CQI.

A combined CQI and a combined ACK/NACK are more compliant with the existing HS-DPCCH format and would simplify implementation. It is possible to use the CQI of the unpaired primary carrier as a reference and compare it with the composite CQI of the paired carriers to produce a switch triggering metric. Thresholds for triggering switching between Carrier Multiplexing and Carrier Diversity can be pre-set based on the different balanced and unbalanced cases shown in Table 1.

The above method can be extended to include the use of Hybrid ARQ (HARQ) for Carrier Diversity as an optional feature. In HSDPA, HARQ is used where a failed packet is retransmitted. The retransmitted packet can contain the same coded bits as the first transmission or additional redundant coding information. A retransmitted signal that is different from the previous one(s) has a different redundancy version (RV). For example the packet of an RV can contain repetition of bits that are not repeated in the previous RV packet. Each packet has a maximum number of allowable retransmissions, which is dependent upon the service of the UE. For example, a voice call cannot tolerate a long delay and therefore less number of retransmissions is desirable by design. For carriers selected for participating in Carrier Diversity, the UE can either perform soft combining or selective combining of the received signals. For soft combining, further gain can be achieved if a different HARQ RV is sent from different carriers that are in the same Carrier Diversity pair. This Parallel HARQ scheme has the advantage of:
1. Pack more HARQ RV to a packet within the same time thereby improving the gain.
2. Reduce the delay of a packet since the same amount of HARQ RV can be sent in parallel simultaneously via two carriers. For example instead of sending four HARQ RVs at sequential periods, a pair of two can be sent at each period thereby reducing the latency by half.

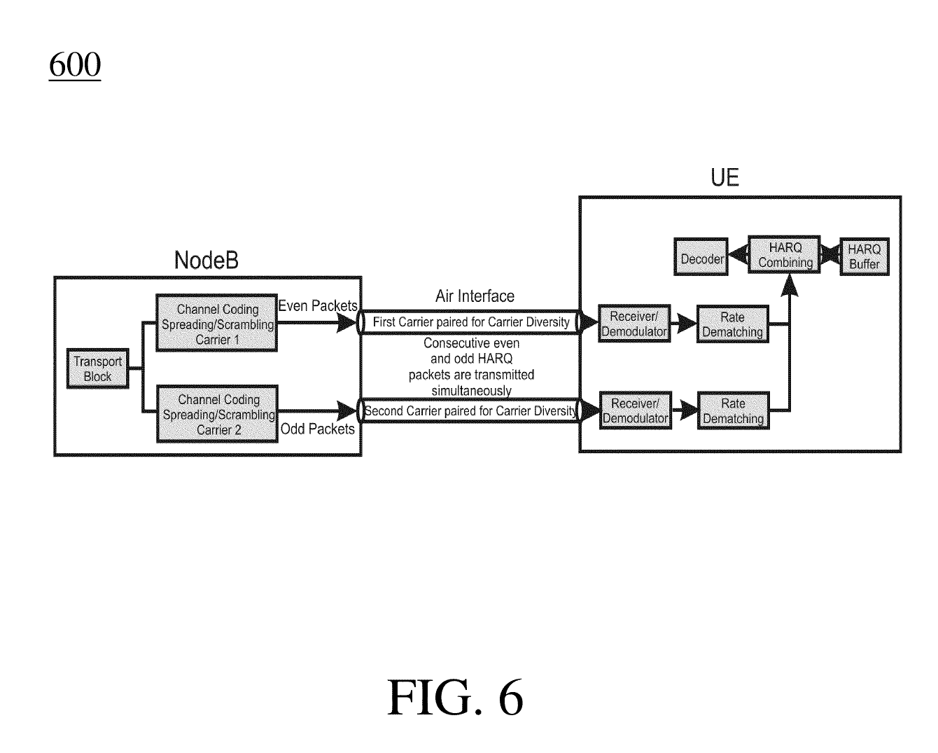

An example of the use of Parallel HARQ is when a mobile is at or beyond cell edge; the number of HARQ retransmissions is expected to increase. In a latency critical application such as VoIP, this would further degrade the voice quality. Instead of transmitting first and subsequent retransmissions in serial in each carrier as in a normal HARQ operation, the first and second (or the first retransmission) HARQ RV transmissions are sent in parallel through two paired carriers. This parallel HARQ scheme is illustrated in diagram 600 of FIG. 6. Pairing of two carriers can be the same as those listed in Table 1. Parallel transmissions help reduce latency for VoIP.

If the data do not contain incremental redundancy, the first and second transmissions contain the same data. The transport blocks can be transmitted with the same rate matching parameters (Chase Combining case). Hence this parallel transmission scheme is equivalent to the transmit diversity approach as described above. On the other hand, if incremental redundancy is used, some of the coded bits in the first and second transmissions are different. Different rate matching parameters (Incremental Redundancy case) are used. This becomes a single HARQ entity in the mobile for both carriers. After the signal of each carrier has been received and after rate de-matching on each carrier's signal, the two signals are combined (similar to HARQ combining) before being passed to the decoder. The combining can be optimized by applying Maximum Ratio Combining for symbols that are common in both transmissions. This approach offers a hybrid partial Carrier Diversity—HARQ with incremental redundancy approach.

In case the signal fails after decoding and a second paired retransmission is required. The mobile requests the base station for a second paired retransmission using the ACK/NACK feedback. Note that in this case, a single ACK/NACK feedback message is sent to the base station as there is one HARQ entity through the primary uplink carrier. The base station then retransmits the next paired transmissions on the two carriers at next HARQ retransmission cycle. When this occurs, the mobile further combines the new paired transmissions (one on each carrier) that it receives with the previous combined transmissions stored in the HARQ buffer.

The detailed and, at times, very specific description above is provided to effectively enable a person of skill in the art to make, use, and best practice the present invention in view of what is already known in the art. In the examples, specifics are provided for the purpose of illustrating possible embodiments of the present invention and should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method, comprising:
in a carrier multiplexing mode, transmitting to a receiver wirelessly and simultaneously via each of a plurality of frequency carriers a different information stream;
determining based upon channel quality information to switch from the carrier multiplexing mode to a carrier diversity mode;
in the carrier diversity mode, transmitting to the receiver wirelessly and simultaneously via each of the plurality of frequency carriers a single information stream.

2. The method as recited in claim 1, further comprising
in the carrier diversity mode, transmitting to the receiver wirelessly and simultaneously via each of the plurality of frequency carriers a Hybrid ARQ (HARQ) transmission.

3. The method as recited in claim 2, wherein the HARQ transmission transmitted via a first carrier of the plurality of frequency carriers has a different redundancy version (RV) than the HARQ transmission transmitted via a second carrier of the plurality of frequency carriers, the first and second carriers being different carriers.

4. The method as recited in claim 1, further comprising
in the carrier diversity mode, transmitting to the receiver wirelessly and simultaneously via each of a second plurality of frequency carriers a second information stream.

5. The method as recited in claim 1, wherein at least one frequency carrier from the plurality of frequency carriers is allocated from each of a plurality of frequency bands.

6. An article of manufacture comprising a processor-readable storage medium storing one or more software programs which when executed by one or more processors performs the steps of the method of claim 1.

7. A method, comprising:
simultaneously receiving wireless signals conveying a single information stream via each of a plurality of frequency carriers;
performing at least one of soft combining or selective combining of the signals received via each of the plurality of frequency carriers;
based upon the received signals, transmitting channel quality information and ACK/NACK information.

8. The method as recited in claim 7, wherein the channel quality information comprises combined channel quality information for the plurality of frequency carriers.

9. The method as recited in claim 7, wherein the ACK/NACK information comprises combined ACK/NACK information for the plurality of frequency carriers.

10. The method as recited in claim 7, further comprising:
simultaneously receiving additional wireless signals conveying a second information stream via each of a second plurality of frequency carriers;
performing at least one of soft combining or selective combining of the additional signals received via each of the second plurality of frequency carriers;
based upon the additional received signals, transmitting additional channel quality information and additional ACK/NACK information corresponding to the second plurality of frequency carriers.

11. The method as recited in claim 10, wherein the additional channel quality information comprises combined channel quality information for the second plurality of frequency carriers.

12. The method as recited in claim 10, wherein the additional ACK/NACK information comprises combined ACK/NACK information for the second plurality of frequency carriers.

13. An article of manufacture comprising a processor-readable storage medium storing one or more software programs which when executed by one or more processors performs the steps of the method of claim 7.

14. A transceiver node of a communication system, the transceiver node being configured to communicate with other wireless devices of the system, wherein the transceiver node is operative
to transmit, in a carrier multiplexing mode, to a receiver wirelessly and simultaneously via each of a plurality of frequency carriers a different information stream,
to determine based upon channel quality information to switch from the carrier multiplexing mode to a carrier diversity mode, and
to transmit, in the carrier diversity mode, to the receiver wirelessly and simultaneously via each of the plurality of frequency carriers a single information stream.

15. A transceiver node of a communication system, the transceiver node being configured to communicate with other wireless devices of the system, wherein the transceiver node is operative
to simultaneously receive wireless signals conveying a single information stream via each of a plurality of frequency carriers,
to perform at least one of soft combining or selective combining of the signals received via each of the plurality of frequency carriers, and
to transmit, based upon the received signals, channel quality information and ACK/NACK information.
